(19) United States
(12) Patent Application Publication
(10) Pub. No.: US 2005/0278204 A1
(43) Pub. Date: Dec. 15, 2005

(54) Auction system

(76) Inventors: Michael Weinberg, Ryebrook, NY (US); Brian P. Milton, Ridgefield, CT (US)

Correspondence Address: CISLO & THOMAS, LLP, 233 WILSHIRE BLVD, SUITE 900, SANTA MONICA, CA, 90401-1211, US

(21) Appl. No.: 11/153,585

(22) Filed: Jun. 14, 2005

Related U.S. Application Data
(60) Provisional application No. 60/579,373, filed on Jun. 14, 2004.

(51) Int. Cl. G06F 17/60

(52) U.S. Cl. 705/7

(57) ABSTRACT

An integrated system for the sale of personal possessions in conjunction with a home. When engaged by a homeowner, a real estate agent can provide optional sales channels for personal possession associated with the existing home that the homeowner may no longer need or want. Providing significant convenience to the homeowner, the real estate agent/auction entity takes care of all or most of the details with respect to the sales of the goods and generally delivers the money minus commissions to the homeowner. This includes cataloguing the items for sale both visually and verbally as well as obtaining minimum price information from the homeowner. Storage services may also be provided if necessary for the homeowner by the real estate agent/auctioning entity.

### CROSS-REFERENCES TO RELATED APPLICATIONS

This patent application is related to and claims priority from U.S. Provisional Patent Application Ser. No. 60/579,373 filed Jun. 14, 2004 entitled AUCTION SYSTEM which application is incorporated herein by this reference thereto.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

This invention relates to auctioning services of personal property, and more particularly to an auctioning system that arises through the coordinated sale of real estate.

2. Description of the Related Art

Auctions, including those for both real property and personal property, are known in the art. Recently, auctioning system have become available online and/or through the Internet such that individuals can easily sell their items to the highest bidder in an easy and convenient manner. Such online auctioning systems generally allow the seller to readily avail himself or herself of local resources and enable the widespread broadcast of such sales information throughout the breadth of the network. For the Internet, this means tens or hundreds of millions of people are able to search for items for sale. In the near future, the number of individuals accessing the Internet may reach the billions. When a person chooses to sell his or her home (the male pronoun is used herein to address individuals generically), there may be a number of personal possessions or items that he may want to dispose of. As the relocation of one's residence or otherwise in the accompaniment of the sale of real property can impose many demands and time constraints, such items may be discarded, moved along with the individual, or given away. Garage sales and the like are also one avenue by which individuals sell their personal possessions prior to or after moving.

With all of the demands of the sale of a home, it is burdensome for an individual to go through and catalogue each item he would like to sell, its minimum price, a description of the item, all for either a standard auction or for an online auction. As a result, many individuals do not realize the benefit of their possessions, including collectibles that may have additional value beyond that of the mere object.

Prior attempts have been made in the art with respect to auctions and otherwise. Brief descriptions of some of such prior attempts are set forth below. While the descriptions are believed to be accurate, no admission is made by them regarding their subject matter which is solely defined by the patent or reference involved.

In Keithley et al., U.S. Pat. No. 5,584,025, the reference is directed to an information processing system for acquiring and displaying information relating to a specific industry or interest, the example herein being real estate and related goods and services. The system comprises a server which has an input/output device for receiving and transmitting data, database files, and database storage. A media terminal for producing files, including digitized property descriptions, is provided. The media terminal has a digitizer for analog/digital signal converting, an I/O device for transmitting, and a data entry device. An end user terminal provides the ability to enter, transmit, receive and display data to and from the file server. An agent's terminal is equipped to enter and display data, as well as transmit information to and from the file server. The system is configured such that real estate information is received at the media terminal, edited, and, once approved, stored at the file server. The information is accessible from either the agent's or end user's terminals. The compilation of information in the databases includes demographic statistics which are usable by advertisers and various industry related entities.

In Brown, U.S. Pat. No. 6,167,386, the reference is directed to an invention which presents a method for conducting an on-line bidding session to accumulate a collective bid for a property. The bidding session is conducted over a computer network that includes a central computer, a number of remote computers, and communication lines connecting the remote computers to the central computer. According to the method, at least one bidding group is registered in the central computer. The bidding group can be an association, institution, or group of investors formed for the purpose of bidding together for the property. The bidding group has a total bid for the property which is tracked in the central computer. The central computer receives bids entered from the remote computers by members of the bidding group. Each bid includes an individual bid amount which is contributed to the total bid of the group to accumulate the collective bid for the property.

In Fisher et al., U.S. Pat. No. 6,243,691 B1, the reference is directed to a system and method for conducting a multi-person, interactive auction, in a variety of formats, without using a human auctioneer to conduct the auction. The system is preferably implemented in software. The system allows a group of bidders to interactively place bids over a computer or communications network. Those bids are recorded by the system and the bidders are updated with the current auction status information. When appropriate, the system closes the auction from further bidding and notifies the winning bidders and losers as to the auction outcome.

In Goino, U.S. Patent Application Publication No. 2001/0056396 A1, the reference is directed to auction methods, auction systems and servers which can satisfy requirements other than the price for a client are provided. An auction client selects a desired one from time slide schemes from a terminal, and enters a due date in an associated entry field. For example, a due date advance scheme is a scheme in which a person who offers the soonest possible trading date from a due date is determined as a successful bidder. Also, specific details (paying-in, delivery and so on) on the trading date for a payment or delivery of an article, requested to a partner, are specified. These bid condition data are transmitted to the server through a network, and the server collects participants in a bid on a home page. The server receives trading dates offered from terminals of participants, and determines a participant who offers the trading date that most satisfies the trade due date condition offered by the client as a successful bidder.

In Jordan, U.S. Patent Application Publication No. 2002/0069157 A1, the reference is directed to a system and method which are disclosed for coordinating an auction for an item between a multi-suction service, a plurality of remote auction services, and a plurality of bidders, all of which are interconnected by a network. The multi-auction service performing the steps of receiving selling parameters for the item to be auctioned from a seller, transmitting the parameters for the item to a plurality of remote auction services, throughout the auction detecting that a bid for the item has been received by at least one of the remote auction services, determining which of the remote auction services should receive a replicated bid, and transmitting a replicated bid to each of the remote auction services so determined. A second embodiment of the invention describes the method wherein more that one remote auction service receives a bid for the item, and wherein the multi-auction service detects that a bid for the item has been received by more than one of the remote auctions services, establishes which of the received bids is an optimal bid for the item, and transmits the optimal bid as the replicated bid to each of the remote auction services.

In Rackson et al., U.S. Pat. No. 6,415,270 B1, the reference is directed to a multi-auction service system and method for replicating an item to be auctioned at a plurality of remote auction services, where the multi-auction service detects bids at the plurality of remote auction services for the item in order to replicate the optimal bid at each of the remote auction services such that the optimal bid is afforded to a bidder or seller.

In Mozley et al., U.S. Patent Application Publication No. 2002/0123959 A1, the reference provides a system and method for providing a real estate auction system. In architecture, the system includes a server device on a network comprising a means for posting a real estate property for auction, a means for acquiring a plurality of data items describing the real estate property for auction from a seller remote device, a means for making the real estate property available at auction to a bidder remote device; and a means for accepting a bid on the real estate property for auction from at least one potential buyer for a predetermined period. The present invention can also be viewed as a method for providing a real estate auction. The method operates by (1) posting a real estate property for auction; (2) acquiring a plurality of data items describing the real estate property for auction; (3) making the real estate property available at auction; and (4) accepting a bid on the real estate property for auction from at least one potential buyer for a predetermined period.

In Broerman, U.S. Pat. No. 6,594,633 B1, the reference is directed to a real estate computer network 10 facilitates a real estate transaction between a buyer 13 and a seller 12 by electronically communicating between the parties 12, 13 and third parties such as a real estate facilitating entities 24 (e.g., lawyer, mortgage provider, title provider) over a network 14, such as or including the Internet 16. Each stage of the transaction is supported by the parties utilizing an online real time interactive communication interface 120 to list property information; to search for a property in a property database 20; to negotiate via an electronic purchase contract 96; and to schedule associated events (e.g., showings) and deadlines (e.g., closing, mortgage filing). Other real estate services are supported, such as electronic mortgage calculator 224, electronic mortgage application 226, searching for comparable sales 92, electronic document delivery 222, and others.

In Mini et al., U.S. Pat. No. 6,684,196 B1, the reference is directed to methods and apparatus which are described for facilitating a transaction corresponding to real property between a seller and a buyer via a network. A negotiation relating to the real property between the buyer and the seller is facilitated via the network. Access by at least one of the buyer and the seller via the network to a plurality of real estate services is provided. Each of the plurality of real estate services relates to an aspect of the transaction, and each of the plurality of real estate services is necessary for the transaction to progress.

As can be seen, while auctions services for real estate, as well as auction services for personal property, are known in the art, there is no coordinated system for the combination of the two especially in conjunction with real estate services such as those offered by Realtors® and real estate agents.

### SUMMARY OF THE INVENTION

In view of the foregoing disadvantages inherent in the known types of auctions now present in the prior art, the present invention provides a new means by which auctions may occur wherein the contents of real property can realize their greatest value in conjunction with the sale of real estate.

The general purpose of the present invention, which will be described subsequently in greater detail, is to provide a coordinated personal property and real property auction system which is not anticipated, rendered obvious, suggested, taught, or even implied by any of the prior art auctions or auction methods, either alone or in any combination thereof.

In view of the foregoing disadvantages inherent in the known types of auction systems now present in the prior art, the present invention provides a coordinated system by which a person may sell his personal possessions or property in conjunction with the sale of his or her home or other real estate.

The general purpose of the present invention, which is described in greater detail below, is to provide an integrated sales method by which a home may be sold via a real estate agent or otherwise along with the coordinated sale of personal possessions which the home owner is choosing to sell.

The present system adds to the list of typical and customary services that a general real estate agent offers a property owner looking to sell his or her property (i.e., in addition to listings, marketing, appointments, open-houses, standard paper work, organizing inspections, etc.) by providing the owner the ability to offer for sale through an online or offline auction system sponsored either by the specific real estate agent (or his or her real estate agency) or a third party auctioneer service, certain or all of the specific property owner's material possessions or personal property that are, in light of that individual's intended relocation, or for any other reason, no longer wanted. Items can include any items, including anything that may not be included in a real estate listing. The present system seeks to sell items that are excluded from the real estate listing. The system may be used to sell practically anything for the customer that has value or perceived value that is not included in the sale of the home or other real estate itself.

Examples of this include the separate sale of furniture of a house for sale or the separate sale of horses/hay/equipment of a barn for sale. A unified process is then provided by the real estate agent that greatly lessens the burden on the home seller. Such burdens may be even greater when the properties for sale are part of an estate for a deceased family member.

The real estate agent (on his or her own, or with the assistance of others in his or her real estate agency or other third persons), may handle the work-intensive tasks required in connection with offering products for sale through an auction (i.e., packaging, shipping, etc.) and has the option of being the main point of contact with the auction service. The initial and/or minimum price for each item can be dictated by the property owner and/or communicated to the real estate agent or other third party chosen to do proper appraisal of items. The items may be offered for sale through various Internet auction sites as well as standard “brick and mortar” auction services, as determined by the real estate agent or third party auction service in his or her sole and reasonable discretion. The items may be marketed and offered for sale domestically and, if commercially reasonable/viable globally. A commission may be paid to the real estate agent for any sale effectuated by such agent. The commission may be a percentage of the agreed upon purchase price, with a guaranteed minimum for each item sold.

Purchasers of items offered through any such auction service may pay the real estate agent directly or through a third party auction service. The agent or third party auctioneer may deduct and/or retain his or her commission and then pay the property owner directly. The intent is to provide the seller with the new and unique ability to not just sell his or her house, but to sell any or all selected material possessions inside the house, all through one agent or third party auction service. Customers may also have the option of listing just the merchandise through the agent and not the house if they like.

The system provides the ability to sell practically anything from a pocket book to the Jaguar® in the garage. The categories can include any and all personal property, including antiques, art, books, business/industrial equipment, cars, other vehicles, clothing, accessories, coins, collectibles, crafts, dolls, bears, electronics, computers, home furnishings, jewelry, watches, movies, DVDs, music, musical instruments, pottery, glass, sporting goods, memorabilia, stamps, tickets, toys, hobbies, etc.

The service may also be listed as, or on, the existing Multiple Listing Service (MLS) listing service real estate agents use to offer homes and/or other real estate. With the present system, such listings may offer the sale of household items as well. The system essentially creates an entirely new feature or new similar service to the MLS listing service that is currently used. The system may create and use a listing sheet for household related items instead of just the house itself which enables a new network of items that can be viewed globally. The new system may be denominated Multiple Listing Content Service (MLCS), consistent with and complementing the current MLS service.

Agents or affiliates using our software or business method may pay licensing and/or transaction fees with a schedule to be determined. The system may also be denominated PPL (personal property listings), PCL (personal content listings) or others of a similar theme. These are preliminary concepts for the name of the system to be determined at a later date, but are mentioned to further clarify the concept.

The real estate agent or agents involved may continually need to assist clients in selling off personal property (e.g., from furniture to kitchen cabinets) in time for the sale. Generally, the system provides a service that may need to be offered as an added value to primary real estate services to promote good will and keep customer loyalty since the real estate agency business is a referral business. By providing sales channels for personal property, the present system enables real estate agents to put a client's mind at ease.

Alternatively, another part of the real estate services available can be to offer a client to whom a house has just been sold, the opportunity to sell anything from the house before renovating. The auction/sales service for personal property does not have to be only with respect to the sales side of real estate, but also on the purchase side.

As an additional alternative, if a buyer should make an offer on a property sold without its contents, the seller may want to take the buyer's offer and list the items for sale with the agent or third party. This alternative enables the seller to offer the home and furnishings for sale together, while enabling the seller to accommodate a buyer who only wants the house.

Further the buyer could also used the method set forth herein when he buys a furnished house and desires to sell any or all of its contents.

In addition, for larger commercial clients this service may be offered to such clients that wish to sell office furniture, etc. in conjunction with the sale of property or the new purchase of property that cam with such item. For example, the purchase of several abodes by a party which requires furnishing might rely upon the real estate agent to effect the same. The present system could be used to provide such purchasing services, possibly in tandem with an interior designer.

Effectively, a real estate agent/office may offer auction service to clients either through its own company which may be private labeled by the agent/office or referred to a third party. The initial client call may go to an answering service from a real estate agent or office. A receiver of the call explains the service, gets relevant information from the client, and sets an appointment. The person receiving the call may be an office manager, but it may be better to have this person focused on running the office while a special liaison initially handles the client.

The real estate agent may call a special liaison person who may be designated as an Estate Concierge Specialist™ (ECS) in the area for which the real estate and/or personal property is involved. Certain types of real estate might require specialization as may certain geographic areas. Additionally, specific types of personal property may require specialization. Such ECS may be specially qualified and trained to maintain standards. The ECS may be called by an answering service, liaison specialist, or otherwise and be assigned the account. The ECS may then schedule and attend an appointment with the client/owner to write up the items in question, get descriptions, take pictures, (particularly digital pictures for easy posting to the internet or otherwise) all in accordance with procedures and guidelines predetermined to maintain quality standards.

The ECS may call the customer to discuss prices after performing pertinent research to finalize certain values for the property with the ECS possibly finding descriptions for the manufacture or for similar descriptive material for similar items on the Internet or otherwise. The items may then be listed under a special account with online auctioning services such as EBay or the like with the customer notified as to the sale or lack thereof of the items by the ECS.

If the item is sold, the ECS may notify a central information contact with an office, for example, or via a website maintainer/office designated EstateAuctioneers.com or otherwise so that the central auctioning organizer/authority may arrange for pickup of the property or otherwise for shipping. The ECS may also aide in the shipping of the customer's items to those who have purchased them via the auction or other process.

Once an appointment is arranged, the customer may be sent the proceeds, minus commission, directly so that it may be received either before or on the day of the pickup of the item. Coordination of these events is important to ensure that items sold are items delivered. By central coordination of the money transaction, the risk of any problems arising may be reduced in coordination with the ECS.

Additionally, if warehousing, storage, or other services are needed, the ECS may provide information, channels, or other avenues to pursue same.

Electronic tutorials or the like may be used to bring individuals seeking ECS status up to speed and through the learning curve. Individuals can monitor the progress of their sales by accessing EBay or other auction houses. Additionally, software or website access to the same type of process as set forth herein might be made available to the customer so that he may (at their own risk) operate as an ECS for themselves by setting prices, taking pictures, and obtaining verbal written descriptions for posting the information to the Internet, online auction system, or other ways.

In this way, a coordinated system is achieved by which individuals selling or buying real estate can also sell and buy associated personal property (e.g., furniture and/or furnishings) to expedite, facilitate, and make more convenient the real estate selling/purchasing/transfer process.

Information, such as results, may be tracked to ensure that efficiencies are being maintained and results for the customer/customer satisfaction are being achieved.

In one embodiment of the present system, method for offering personal property for sale in conjunction with the sale of real estate is provided that includes providing an agent for the sale of real estate being sold by an owner, the real estate having associated with it personal property owned by the same owner or otherwise. Invitations or solicitations of the owner to sell said personal property are made via or on behalf of the agent or another in order to coordinate sale of said real estate with sale of said personal property. A catalogue of the personal property is made for sales purposes in order to provide one or more catalogue entries. The catalogue entries are published in offering the personal property for sale. The agent or another then receives proceeds from a buyer of the personal property who then transmits the personal property to the buyer. In this way, the owner may sell personal property associated with real property via the agent in an easy and convenient manner.

In one embodiment of the present invention, a method for offering personal property for sale in conjunction with the sale of real estate is provided that includes providing an agent for the sale of real estate, the real estate being sold by an owner. The real estate has associated with it personal property owned by the owner. The owner is invited and/or solicited the sale of personal property via the agent in order to coordinate sale of the real estate with sale of the personal property. Cataloguing of the personal property occurs for sales purposes to provide at least one catalogue entry. The personal property is offered for sale by publication of the catalogue entry with the buyer receiving the proceeds of the personal property. The personal property is then transmitted to the buyer, whereby the owner may sell personal property associated with real property via the agent in an easy and convenient manner.

In another embodiment, a method for offering personal property for sale in conjunction with the sale of real estate is set forth that includes providing an agent for the sale of real estate, the agent selected from the group consisting of real estate agents, realtors, and combinations thereof. The real estate is sold by an owner with the real estate being a home residence of the owner. The real estate has associated with it personal property owned by the owner, with the personal property selected from the group consisting of furniture, furnishings, fixtures, livestock, and combinations thereof. The owner is then invited and/or solicited to sell the personal property via the agent in order to coordinate sale of the real estate with sale of the personal property, the inviting or soliciting the owner achieved via communication channels selected from the group consisting of verbal communications written communications, and combinations thereof. Cataloguing the personal property for sales purposes occurs to provide a catalogue entry by recording a walk-through of the premises of the real estate with the owner or a representative thereof and generating records selected from the group consisting of visual recording, audio recording, and combinations thereof and also by generating records selected from the group consisting of a verbal description of the personal property, a written description of the personal property, a visual description of the personal property, a description of a minimum price the owner would accept for the personal property, and combinations thereof. The personal property is then offered for sale by publication of the catalogue entry via sales channels selected from the group consisting of standard auction channels, online auction channels, and combinations thereof. Proceeds from a buyer of the personal property are received and the personal property is transmitted to the buyer so that the owner may sell personal property associated with real property via the agent in an easy and convenient manner.

### BRIEF DESCRIPTION OF THE DRAWINGS

FIG. 1 is a flow chart view of steps included in the present system.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

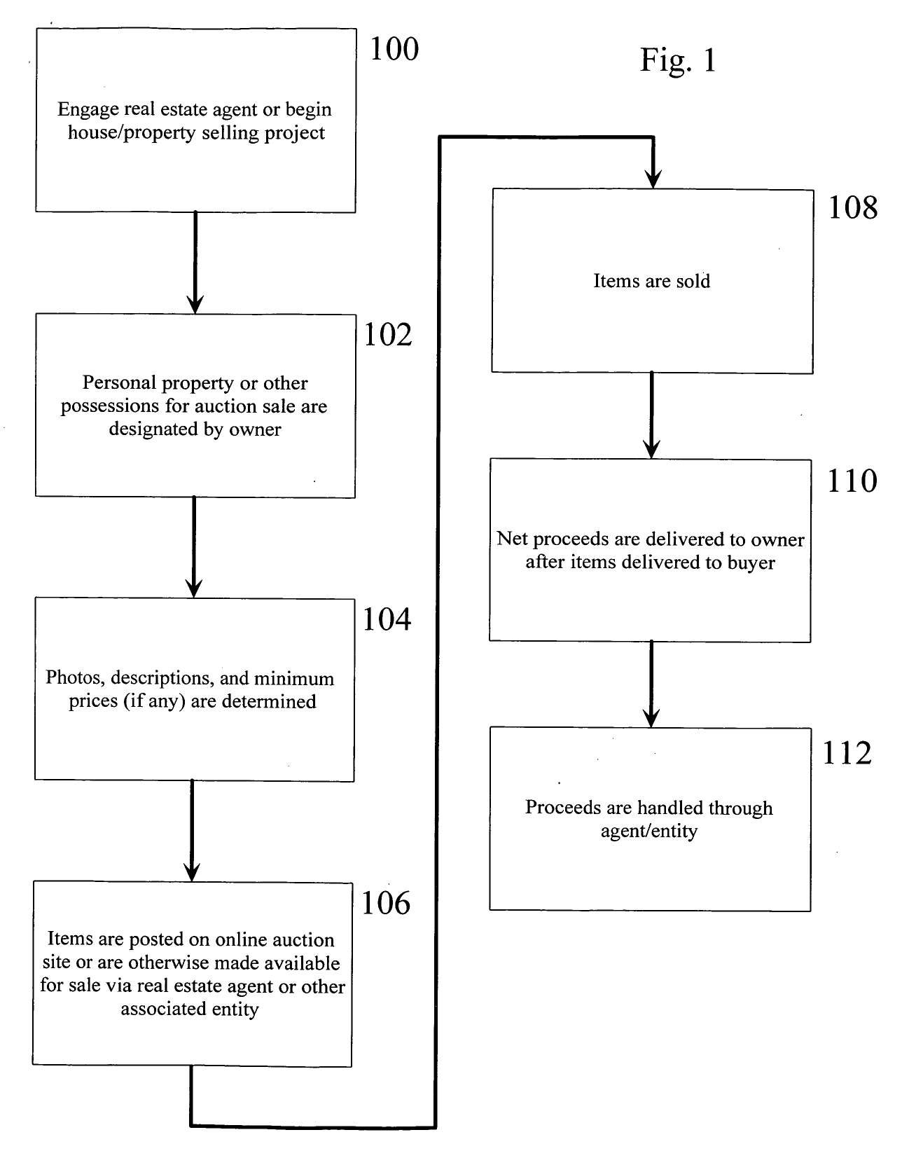

Referring to the drawing where like numerals of reference designate like elements throughout it will be noted that, as shown in accompanying FIG. 1, the present system provides means by which those who sell, vend, lease, rent, or otherwise handle real estate transactions for others can also provide additional services in a coordinated and integrated fashion.

In FIG. 1, a homeowner may first engage a real estate agent or begin a house/property selling project 100. Such engagement of a real estate agent is set forth in an exemplary manner only herein as that of the sale of a home by the owner and resident of a single family dwelling. However, the example set forth herein is not meant to be one of limitation, but basically one of a foundation for a variety of different embodiments that may depart significantly from the example set forth herein, all of which are contemplated as being within the scope of the present invention. Such different embodiments may include (by way of example and not of limitation) commercial and multiple-family properties as well.

Upon engaging a real estate agent 100, the real estate agent may proceed with the normal process of selling the real estate involved. This includes listing the property, showing the property, and handling aspects of the transaction that all fall within past, present, and future real estate transaction processes.

As an additional option that the real estate agent may provide the home owner, the real estate agent may provide a channel through which the homeowner can sell certain items related to the home that the homeowner will no longer need or want especially with respect to the move into the new dwelling.

A number of reasons arise as to why an individual would want to sell personal possessions in conjunction with the sale of a home. For example, the new home may be smaller than the current home as when older individuals whose children have moved out of the house move into a smaller dwelling having a smaller number of bedrooms. The need for space is less because the family is smaller and the homeowner may realize benefits and financial gain from selling surplus personal property.

If the homeowner so decides, the real estate agent can begin a tandem process by which the indicated or selected personal property items are designated 102 by the owner.

The designation process may be achieved as by a mere walk-through of the premises with the real estate agent holding a video camera and the owner indicating which items are for sale. A list or other more permanent record can then be established for certain individual items which are then subject to better photography or visual recordation for public display or publication. A written verbal description can then be made of each of the pertinent items and the owner may indicate a minimum price below which he would not sell the item. In this way, especially with the use of an initial video camera walk-thorough, the homeowner can easily designate those items that he would like to sell. With respect to items that have been stored in an attic or other long term storage, the video walk-though method may serve the parties well, however other means that are now known or later developed may be used to catalogue and prepare the items for sale.

Once the items are designated 102 photos, descriptions, and minimum prices (if any) are determined 104 and the items may be stored in a warehouse, kept on the premises, or otherwise while the individual is now free to focus his attention upon the impending sale of the residence and move to a new residence or otherwise without being hindered or impeded by concerns worries or cares about the items for sale. The items that are kept by the individual are then subject to moving services and the like for transfers to the new dwelling.

After the items have been catalogued 104, they may then be made available for auction 106. Such a selling process may take advantage of auctioning or other sales methods now known or later developed including both standard auction houses (“brick and mortar”) or online auction systems. During this process, the individual homeowner is not burdened with the details with respect to the auction. Instead, it is the real estate agent who then handles all of the activity with regards to the sale of the items either by himself or in conjunction with designated and trustworthy third parties.

Once the items have been posted for sale, they either will or will not be sold. Items may have no bids or bids under the minimum, and are consequently not sold. These items may be donated to charity, given to friends, kept, or otherwise disposed of.

With respect to those items that do sell, the proceeds of the sale may then be collected by the real estate agent or other designated third party affecting the auction. A commission may be taken by the real estate agent/third party as payment for the auction services. This commission is generally above and beyond any commission taken by the auction house/online auction system.

After the proceeds have been collected by the real estate agent, the items may be delivered to the buyer 110 who has purchased the items via auction. The real estate agent may then act as a temporary escrow holder, holding the funds in trust for the homeowner until the items are delivered to the buyer. Once the items are delivered to the buyer, the proceeds may then be distributed to the homeowner.

The proceeds arising from the sale via auction or otherwise may then be used to offset additional costs or expenses, and/or saved or spent according to the preferences of the homeowner.

The proceeds are handled through the agent/entity 112 responsible for the auctioning of the goods. In this way, the real estate agent/auctioning entity is ensured payment and acts as a check upon possibly unscrupulous sellers of real estate who might fraudulently obtain auction proceeds without delivering the associated goods.

The items offered for sale generally need to sell before the real estate title passes. The agent (or other party) may have the right to stop selling the items at anytime. This ensures that the homeowners do not expect the agent/other party to store and/or pay for storage of the items if they are not sold by the time the house sells.

Several advantages are achieved by the coordinated sales activity of both real property and personal property in an integrated fashion. The ability to auction items in conjunction with real estate sales frees the real property owner from having to trouble themselves with respect to such sales. Such sales can be troubling and it is not uncommon for individuals to pack at the last moment or delay decisions with respect to such personal property. In some cases, the movers of the items are sometimes the one to collect upon the homeowners haste in disposing of them, the homeowner leaving such items with the mover, abandoning them on the prior premises or otherwise.

In selling personal property in conjunction with a home sale, the homeowner is able to cover or recover the costs of the home sale as well as save on moving expenses. Storage expenses are also saved and it gives the individual an opportunity to sell unwanted household items, automobiles, or otherwise. There is no need for the homeowner to conduct a garage sale, taking up his valuable time during a busy transitional stage. Additionally, the cataloguing of items often allows individuals to find hidden “treasures,” or other items of value to the individual or to the market that the homeowner had forgotten about until they were rediscovered.

It is very convenient for a homeowner to have a third party handle the auctioning of unwanted personal possessions. Additionally, the use of the real estate agent/third party auctioning entity can provide additional seller credibility with respect to the auction marketplace.

Items that may have been left behind by the prior homeowner may also be sold as abandoned property by a new homeowner who no longer wants such property. Furthermore, and as set forth above, it is possible through video recording techniques or otherwise to provide a virtual tour of the home and its contents when applicable. Individuals seeking to buy such items at auction can then see the setting in which such items were presented in the individual's home. Some individuals may not want to provide access to such information or may otherwise want to guard their privacy further, but the option is available for virtual tours of the individual home with the items for sale.

Contractors, dismantlers, or the like can provide services by which fixtures such as chandeliers or other permanent items can be safely and carefully removed from the home to subject them to sale.

Computer-or otherwise-implemented software may be used to effect the steps set forth herein to the extent possible. Particularly, steps 102-112 may be handled electronically save for the delivery of purchased items to the buyer (unless such purchased items may be delivered electronically).

While the present invention has been described with regards to particular embodiments, it is recognized that additional variations of the present invention may be devised without departing from the inventive concept of providing a personal property brokerage service in conjunction with the sale of real estate as set forth herein.

1. A method for offering personal property for sale in conjunction with the sale of real estate, comprising:
providing an agent for the sale of real estate, said real estate being sold by an owner;
said real estate having associated with it personal property owned by said owner;
inviting or soliciting said owner to sell said personal property via said agent in order to coordinate sale of said real estate with sale of said personal property;
cataloguing said personal property for sales purposes to provide a catalogue entry;
offering said personal property for sale by publication of said catalogue entry;
receiving proceeds from a buyer of said personal property; and
transmitting said personal property to said buyer; whereby
said owner may sell personal property associated with real property via said agent in an easy and convenient manner.

2. A method for offering personal property for sale in conjunction with the sale of real estate as set forth in claim 1, further comprising:
said agent selected from the group consisting of real estate agents, realtors, and combinations thereof.

3. A method for offering personal property for sale in conjunction with the sale of real estate as set forth in claim 1, further comprising:
said real estate being a home residence of said owner.

4. A method for offering personal property for sale in conjunction with the sale of real estate as set forth in claim 1, wherein said personal property further comprises:
personal property selected from the group consisting of furniture, furnishings, fixtures, livestock, and combinations thereof.

5. A method for offering personal property for sale in conjunction with the sale of real estate as set forth in claim 1, wherein said step of inviting or soliciting said owner further comprises:
inviting or soliciting said owner by communication channels selected from the group consisting of verbal communications written communications, and combinations thereof.

6. A method for offering personal property for sale in conjunction with the sale of real estate as set forth in claim 1, wherein said step of cataloguing further comprises:
recording a walk-through of the premises of said real estate with said owner or a representative thereof.

7. A method for offering personal property for sale in conjunction with the sale of real estate as set forth in claim 6, wherein said step of recording said walk-through further comprises:
generating records selected from the group consisting of visual recording, audio recording, and combinations thereof.

8. A method for offering personal property for sale in conjunction with the sale of real estate as set forth in claim 7, wherein said step of generating records further comprises:
generating records selected from the group consisting of a verbal description of said personal property, a visual description of said personal property, a description of a minimum price said owner would accept for said personal property, and combinations thereof.

9. A method for offering personal property for sale in conjunction with the sale of real estate as set forth in claim 1, wherein said step of offering said personal property for sale further comprises:
offering said personal property for sale via sales channels selected from the group consisting of standard auction channels, online auction channels, and combinations thereof.

10. A method for offering personal property for sale in conjunction with the sale of real estate, comprising:
providing an agent for the sale of real estate, said agent selected from the group consisting of real estate agents, realtors, and combinations thereof;
said real estate being sold by an owner, said real estate being a home residence of said owner;
said real estate having associated with it personal property owned by said owner, said personal property selected from the group consisting of furniture, furnishings, fixtures, livestock, and combinations thereof;
inviting or soliciting said owner to sell said personal property via said agent in order to coordinate sale of said real estate with sale of said personal property, said inviting or soliciting said owner achieved via communication channels selected from the group consisting of verbal communications written communications, and combinations thereof;
cataloguing said personal property for sales purposes to provide a catalogue entry by recording a walk-through of the premises of said real estate with said owner or a representative thereof and generating records selected from the group consisting of visual recording, audio recording, and combinations thereof and also by generating records selected from the group consisting of a verbal description of said personal property, a written description of said personal property, a visual description of said personal property, a description of a minimum price said owner would accept for said personal property, and combinations thereof;
offering said personal property for sale by publication of said catalogue entry via sales channels selected from the group consisting of standard auction channels, online auction channels, and combinations thereof;
receiving proceeds from a buyer of said personal property; and
transmitting said personal property to said buyer; whereby
said owner may sell personal property associated with real property via said agent in an easy and convenient manner.
